(19) United States
(12) Patent Application Publication
(10) Pub. No.: US 2011/0050888 A1
(43) Pub. Date: Mar. 3, 2011

(54) INSPECTION SYSTEM, MOBILE TERMINAL, INSPECTION METHOD, AND RECORDING MEDIUM

(75) Inventors: Tomoe SHIBUKAWA, Tokyo (JP); Yusuke Omori, Tokyo (JP); Toshimitsu Fukushima, Tokyo (JP)

(73) Assignee: FUJIFILM CORPORATION, Tokyo (JP)

(21) Appl. No.: 12/868,386

(22) Filed: Aug. 25, 2010

(30) Foreign Application Priority Data
Aug. 27, 2009 (JP) JP2009-197150
Mar. 23, 2010 (JP) JP2010-066410

(51) Int. Cl. H04N 7/18; H04M 1/00

(52) U.S. Cl. 348/135; 455/556.1; 348/E07.085

(57) ABSTRACT

First, a mobile terminal displays a parent evidence photo previously selected on an image display and then accepts a specification of an association position, which is a desired position for associating a child evidence photo on the parent evidence photo through an operation device. And then, the mobile terminal accepts an instruction to shoot an image from a user, and starts shooting and stores the shot the child evidence photo in a memory. The child evidence photo stored in the memory is displayed on the image display. The mobile terminal associates the child evidence photo stored in the memory with the ID of the parent evidence photo, coordinate information indicating the specified position on the parent evidence photo, and the shooting point ID uniquely allocated to the position, and then stores the associated child evidence photo in the memory again.

### BACKGROUND OF THE INVENTION

1. Field of the Invention

The presently disclosed subject matter relates to a system supporting an inspection work.

2. Description of the Related Art

Conventionally, there has been developed a system for efficiently performing a construction inspection work in a construction such as a building construction, for example, an inspection called a reinforcement inspection for checking a rebar arrangement state.

According to Japanese Patent Application Laid-Open No. 2006-146682, the mobile terminal stores a construction photo checklist including a shot drawing of each construction to be shot, a construction name of each construction to be shot, and a construction design value. Then, based on selection from the stored shot drawings of construction and constructions in the construction photo checklist according to a user's input operation, the mobile terminal generates shooting data including the shot drawing of the selected construction, the construction name, the construction design value and an actual measurement value of the construction input by the user's operation. Then, the mobile terminal obtains photo data of construction according to camera shooting operation in a state in which the shooting data is displayed. Then, the mobile terminal writes the photo number of shot construction and actual measurement value of the shot construction in the construction photo checklist. Finally, the mobile terminal transmits the shooting data of each construction and the updated construction photo checklist to an external construction photo editing apparatus.

According to Japanese Patent Application Laid-Open No. 2001-111947, a recording apparatus which records shot images includes a shooting unit which inputs a plurality of images; a buffer memory which temporarily stores the inputted image; a processing unit which generates a target image file; a recording unit which records the target image file; an image display unit which list-displays a plurality of images; and a selection input unit which specifies the target image from the list-displayed images.

### SUMMARY OF THE INVENTION

However, in consideration of a system which streamlines construction inspection work in a construction work using a mobile information terminal, the techniques disclosed in Japanese Patent Application Laid-Open No. 2006-146682 and Japanese Patent Application Laid-Open No. 2001-111947 have a problem that when a shooting point of an inspection photo to be taken at inspection is determined on a drawing, it is difficult to indicate the position in a vertical direction to the shooting point, in the after-shot image. Moreover, the techniques disclosed in Japanese Patent Application Laid-Open No. 2006-146682 and Japanese Patent Application Laid-Open No. 2001-111947 have another problem that when a detailed image (close up image) is shot, it is difficult to understand which place around the shooting point is shot, after inspection. In other words, when a plurality of photos is taken at a shooting point, it is difficult to definitely keep an association of each image. The technique disclosed in Japanese Patent Application Laid-Open No. 2001-111947 can provide an association of images such as a parent image and a child image, but an association such as positional specification (designation) on an image is not allowed.

In view of the above, the presently disclosed subject matter allows a mobile information terminal to be used to specify (designate) a shooting point of an inspection photo at inspection on a drawing or an image, thereby enabling information as to a vertical or horizontal direction to be held and further enabling structured inspection image information having an association between an entire image (whole image) and a detailed image to be generated.

The presently disclosed subject matter provides an inspection system comprising an inspection sheet generation apparatus and a mobile terminal, wherein the inspection sheet generation apparatus comprises: an inspection information input unit which inputs inspection information on an inspection object and drawing information on the inspection information; and an inspection sheet generation unit which generates an inspection sheet based on the inspection information and the drawing information inputted by the inspection information input unit, and wherein the mobile terminal comprises: a display unit which displays the inspection information and the drawing information based on the inspection sheet generated by the inspection sheet generation unit; an inspection result input unit which inputs an inspection result corresponding to the inspection object; a shooting point input unit which inputs a shooting point of the inspection object; a shooting unit which can shoot a plurality of images including a first image and a second image assuming the inspection object as an object to be shot; an association position specifying unit which specifies an association position, which is a position to be associated with the second image, of desired positions on the first image shot by the shooting unit; and a storage unit which stores inspection result data associating the first image and the second image with the inspection result inputted by the inspection result input unit, the shooting point inputted by the shooting point input unit, and the association position specified by the association position specifying unit.

Preferably, the inspection system has a transmission unit which transmits inspection result data stored in the storage unit to a predetermined server.

The server may comprise: a table storage unit which stores a table associating an inspection result content and a failure handling request form; a receiving unit which receives inspection result data; and a generation unit which determines a form corresponding to an inspection result indicated by inspection result data received by the receiving unit and generates failure handling request information based on the determined form and the inspection result data.

Preferably, the association position includes a vertical and/or horizontal shooting direction of the second image in the first image.

The presently disclosed subject matter provides a mobile terminal including: a display unit which displays inspection information and drawing information based on an inspection sheet containing inspection information on an inspection object and drawing information on the inspection information; an inspection result input unit which inputs an inspection result corresponding to the inspection object; a shooting point input unit which inputs a shooting point of the inspection object; a shooting unit which can shoot a plurality of images including a first image and a second image assuming the inspection object as an object to be shot; an association position specifying unit which specifies an association position, which is a position to be associated with the second image, of desired positions on the first image shot by the shooting unit; and a storage unit which stores inspection result data associating the first image and the second image with the inspection result inputted by the inspection result input unit, the shooting point inputted by the shooting point input unit, and the association position specified by the association position specifying unit.

Preferably, the display unit associates the association position of the first image with the second image based on the inspection result data stored in the storage unit for displaying.

Preferably, the shooting point input unit selects position information of a desired inspection place from a plurality of predetermined inspection places on the drawing information.

Preferably, the shooting point input unit inputs position information of arbitrary inspection place on the drawing information.

The presently disclosed subject matter provides an inspection method to be performed by a mobile terminal equipped with a camera, comprising: displaying inspection information and drawing information based on an inspection sheet containing inspection information on an inspection object and drawing information on the inspection information; inputting an inspection result corresponding to the inspection object; inputting a shooting point of the inspection object; shooting a plurality of images including a first image and a second image assuming the inspection object as an object to be shot; specifying an association position, which is a position to be associated with the second image, of positions on the shot first image; and storing inspection result data associating the first image and the second image with the inputted inspection result, the inputted shooting point, and the specified association position.

The presently disclosed subject matter provides a recording medium storing a program including computer-executable instructions to be performed by a mobile terminal equipped with a camera, the instructions comprising: displaying inspection information and drawing information based on an inspection sheet containing inspection information on an inspection object and drawing information on the inspection information; inputting an inspection result corresponding to the inspection object; inputting a shooting point of the inspection object; shooting a plurality of images including a first image and a second image assuming the inspection object as an object to be shot; specifying an association position, which is a position to be associated with the second image, of positions on the shot first image; and storing inspection result data associating the first image and the second image with the inputted inspection result, the inputted shooting point, and the specified association position.

The presently disclosed subject matter can associate a desired position of a higher-level inspection photo with data of a lower-level inspection photo, and visually present the association between the higher-level inspection photo and lower-level inspection photo.

### BRIEF DESCRIPTION OF THE DRAWINGS

FIG. 1 is a schematic configuration view of a construction inspection system;

FIG. 2 illustrates an outline of process contents of the construction inspection system;

FIG. 3 is a block diagram of a camera-equipped mobile terminal;

FIG. 4 is a flowchart of an inspection sheet generation process;

FIG. 5 is a flowchart of an inspection work process;

FIG. 6 is an example of a framing plan;

FIG. 7 is a selection example of an inspection object member;

FIG. 8 is a display example of inspection contents and a member drawing corresponding to a selected inspection object member;

FIGS. 9A to 9C are an example of an inspection point specification, an example of an inspection photo, and an example of an inspection result input for arbitrary point inspection;

FIG. 10 is a flowchart of an inspection photo association process;

FIGS. 11A to 11C are a display example of a framing plan, a display example of a member, and a display example of an inspection photo for fixed-point inspection;

FIGS. 12A and 12B respectively illustrate examples of a viewer screen and an inspection point selection screen and a display example of an icon of a child inspection photo for arbitrary point inspection;

FIGS. 13A to 13C illustrate an example of an association position specification;

FIG. 14 illustrates another example of an association position specification;

FIG. 15 is a display example of a child inspection photo for fixed-point inspection;

FIG. 16 is a display example of a child inspection photo for arbitrary point inspection;

FIG. 17 is a flowchart of an inspection photo re-association process;

FIG. 18 is an example of an inspection report generation screen;

FIG. 19 is an example of an inspection report output screen;

FIG. 20 is a flowchart of a failure handling request process;

FIG. 21 is an example of a failure handling request table;

FIG. 22 is a schematic explanatory drawing of an example of applying this system (inspection at construction site);

FIG. 23 is a schematic explanatory drawing of an example of applying this system (inspection and maintenance of a utility pole); and

FIG. 24 is a schematic explanatory drawing of an example of applying this system (inspection and maintenance of a plant).

### DETAILED DESCRIPTION OF THE PREFERRED EMBODIMENTS

### First Embodiment

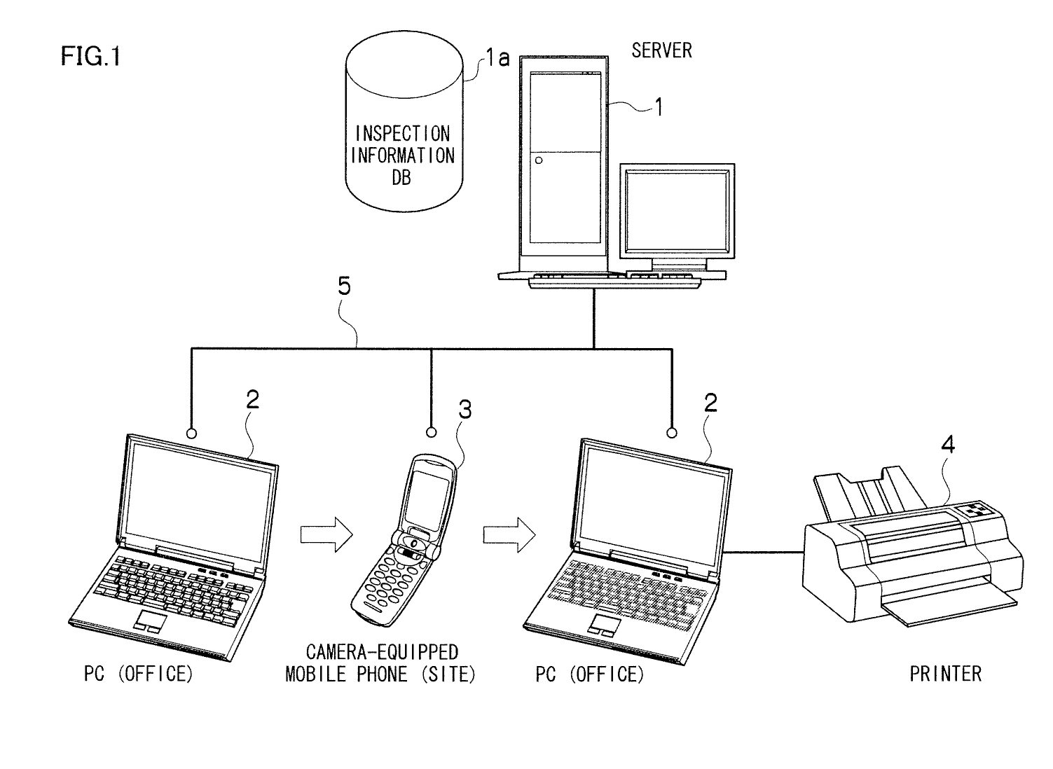

FIG. 1 shows a schematic configuration of a construction inspection system according to a preferred embodiment of the presently disclosed subject matter. The system includes a server 1, personal computers (PCs) 2, and a camera-equipped mobile terminal 3. The server 1, the personal computers 2, the camera-equipped mobile terminal 3, and the printer 4 can be connected to each other via a network 5. The network 5 may be routed in any way manner and can be built through a well-known communication device such as a wireless network including a mobile communication network, the Internet, a LAN (Local Area Network), an infrared communication, and a Bluetooth; or a wired network such as a USB (Universal Serial Bus) cable, or a combination of all or a part thereof. The network 5 may be any data communication network with on-demand connection and is not limited to a network with always-on connection.

The server 1 has an inspection information DB (database) 1a for centralized management of inspection information. The server 1 and the personal computers 2 each can be configured of a computer (having circuits required for arithmetic operation of a CPU (Central Processing Unit), a RAM (Random Access Memory), a ROM (Read Only Memory), and the like, a data storage medium, a data input/output circuit, a display circuit, an operation apparatus, a communication circuit, and the like). The inspection information DB 1a can be configured of a large capacity storage medium such as a hard disk unit.

The inspection information stored in the inspection information DB 1a includes construction object names, inspection drawings, inspection types (reinforcement inspection, etc.), inspection places (floor number of the building, etc.), inspection objects (pillar, beam, wall, etc.), inspection items (type, number, pitch, etc.), and inspection points (points enclosing a cross section of a pillar from outside arranged in equal distance, etc.). The inspection drawing includes a sketch drawing (framing plan) and a member drawing (reinforcement drawing, sectional drawing, etc.). The member drawing and the inspection object are associated with a position of each member arranged in the sketch drawing.

In the following description, “arbitrary point inspection” refers to a process in which an inspection drawing is displayed on the mobile terminal 3; arbitrary inspection place on the inspection drawing is specified; an inspection result and an inspection photo corresponding to the specified inspection place are acquired by the mobile terminal 3; and the inspection result and the inspection photo are associated with each other and stored in a predetermined storage medium (e.g., inspection information DB 1a). On the other hand, “fixed-point inspection” refers to a process in which an inspection drawing is displayed on the mobile terminal 3; arbitrary inspection place on the inspection drawing is specified from preliminarily specified inspection places; an inspection result and an inspection photo corresponding to the specified inspection place are acquired by the mobile terminal 3; and the inspection result and the inspection photo are associated with each other and stored in a desired storage medium.

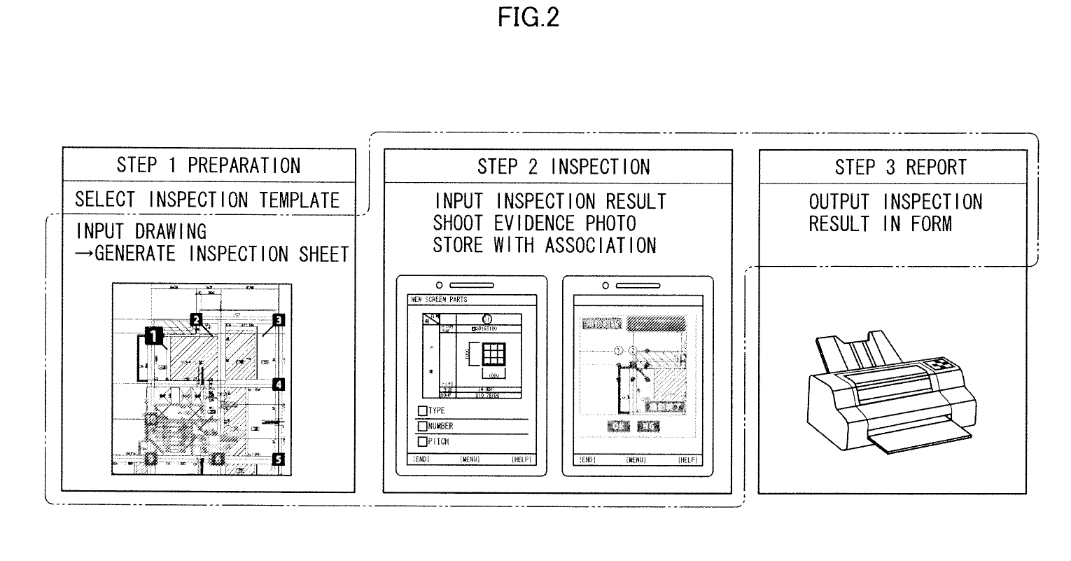

FIG. 2 illustrates an outline of process content of the construction inspection system. The inspection system executes inspection sheet generation (Step 1), inspection result input and inspection photo shooting (Step 2), and inspection report output on which the inspection result is reflected (Step 3). The specific flow of these processes will be described later.

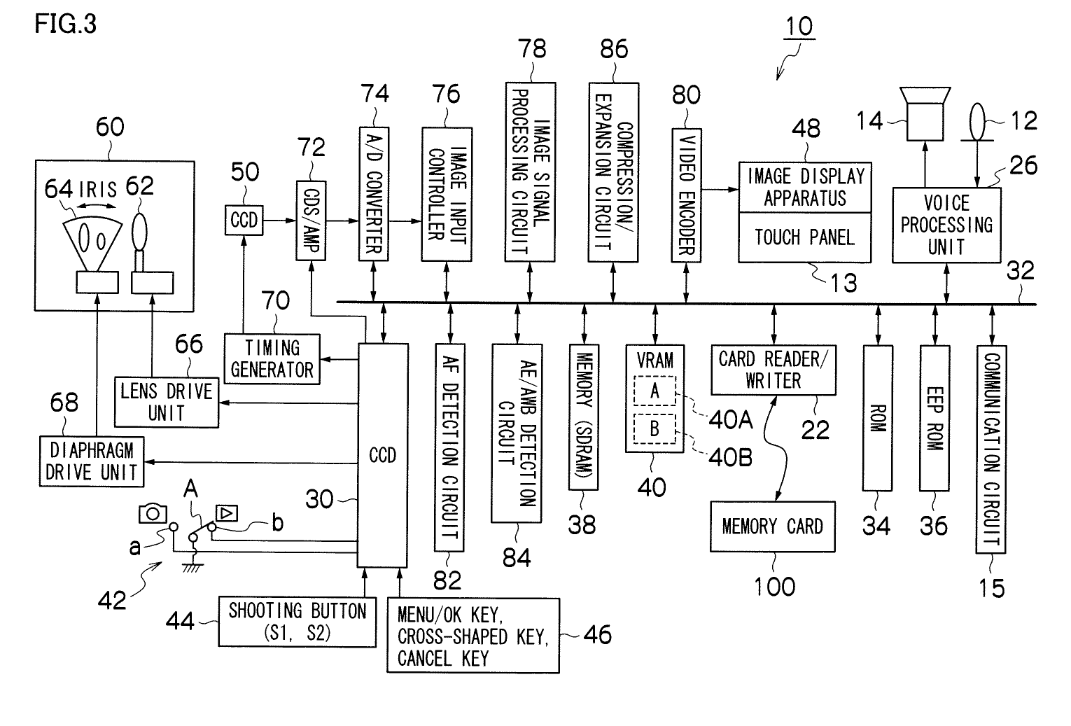

FIG. 3 illustrates a configuration of the camera-equipped mobile terminal 3. The entire operation of the camera-equipped mobile terminal 3 is integratedly controlled by a central processing unit (CPU) 30. The CPU 30 functions as a control device which controls the operation according to a predetermined program as well as functions as an arithmetic operation device which performs various arithmetic operations such as an automatic exposure (AE) operation, an automatic focus (AF) adjustment operation, and a white balance (WB) adjustment operation.

Programs to be executed by the CPU 30 and various data required for control are stored in the ROM 34 connected to the CPU 30 via a bus 32. CCD (Charge-Coupled Device) pixel fault information, various constants and information on camera operation are stored in an EEPROM (Elecrronically Erasable and Programmable ROM) 36.

A memory such as SDRAM (Synchronous Dynamic RAM) 38 is used as a program load area and an operation work area of the CPU 30 as well as a temporary storage area of image data and voice data. A VRAM (Video RAM) 40 is a temporary storage memory dedicated to image data and includes an area A 40A and an area B 40B. The memory 38 and the VRAM 40 can be shared.

The camera-equipped mobile terminal 3 includes a mode selection switch 42, a shooting button 44, and an operation device 46 including a menu/OK key, a cross-shaped key, a cancel key, a jog dial, a touch panel 13, and the like. Each signal from the various operation units (42 to 46) is inputted to the CPU 30. The CPU 30 controls each circuit of the camera-equipped mobile terminal 3 based on an input signal, the control including lens drive control, shooting operation control, image processing control, image data recording/reproducing control, and display control of an image display apparatus 48.

The touch panel 13 is laminated on the image display apparatus 48 and sends, to the CPU 30, an electrical signal indicating a pressing position corresponding to a screen coordinate of the image display apparatus 48. The touch panel 13 is one of the components of the operation device 46. The CPU 30 determines an action on the touch panel 13 in a display region of the image display apparatus 48, for example, a single tap, a double tap, and a tap and drag (flick action). The single tap refers to an input of a single pressing position; the double tap refers to an input of double different pressing positions; and the tap and drag (flick action) refers to an input of a pressing position which starts at a first detected pressing position and continuously slides to another position. The double tap or the tap and drag is similar to indicating diagonal points of a rectangular region, and thus the user can easily intuitively understand what rectangular region is specified.

The mode selection switch 42 is an operation device for switching between a shooting mode and a reproduction mode. When a movable armature 42A is connected to a contact point “a” by operating the mode selection switch 42, a corresponding signal is inputted to the CPU 30, and the camera-equipped mobile terminal 3 is set to the shooting mode. When the movable armature 42A is connected to a contact point “b”, the camera-equipped mobile terminal 3 is set to the reproduction mode for reproducing a recorded image.

The shooting button 44 is an operation button for inputting a shooting start instruction and is composed of a two-stage stroke switch having a switch S1 which is turned on when the switch is half-pressed and a switch S2 which is turned on when the switch is fully-pressed.

The image display apparatus 48 is configured of a liquid crystal display capable of color display and other display devices. The image display apparatus 48 can be used as an electronic finder for angle-of-view confirmation at shooting as well as is used as a device for reproducing and displaying a recorded image. Moreover, the image display apparatus 48 is also used as a user interface display screen on which information such as menu information, selection items, and setting contents is displayed as needed.

When a shooting mode is selected by the mode selection switch 42, power is supplied to an imaging unit including a color CCD solid imaging element (hereinafter referred to simply as a CCD) 50 to enter a shootable state.

The lens unit 60 is an optical unit including a shooting lens 62 having a focus lens and a mechanical shutter 64 also serving as a diaphragm. The lens unit 60 is electrically driven by the lens drive unit 66 and the diaphragm drive unit 68 controlled by the CPU 30 for zoom control, focus control and iris control.

The light transmitted through the lens unit 60 is focused on a light receiving surface of the CCD 50. A large number of photodiodes (light receiving elements) are arranged two-dimensionally on the light receiving surface of the CCD 50. Primary color filters of red (R), green (G), and blue (B) are arranged in a predetermined array structure (such as Bayer and G stripe) corresponding to each photodiode. The CCD 50 has an electronic shutter function to control a charge storage time (shutter speed) of each photodiode. The CPU 30 controls the charge storage time in the CCD 50 through a timing generator 70. Note that the CCD 50 may be replaced with an imaging element in another format such as an MOS type.

An object image focused on the light receiving surface of the CCD 50 is converted to a signal charge with an amount corresponding to an incident light amount by each photodiode. A signal charge stored in each photodiode is sequentially read as a voltage signal (image signal) corresponding to the signal charge based on a drive pulse supplied from the timing generator 70 in response to an instruction of the CPU 30.

The signal outputted from the CCD 50 is fed into an analog processing unit (CDS/AMP) 72, where the R, G, and B signals of each pixel undergo sampling hold (correlated double sampling), and after amplification, are fed into an A/D converter 74. The dot-sequential R, G, and B signals converted to a digital signal by the A/D converter 74 are stored in a memory 38 via an image input controller 76.

The image signal processing circuit 78 processes the R, G, and B signals stored in the memory 38 in response to an instruction of the CPU 30. That is, the image signal processing circuit 78 functions as an image processing device including a synchronization circuit (processing circuit which interpolates a spatial displacement of a color signal due to a single-plate CCD color filter array and converts the color signal to a synchronization system), a white balance correction circuit, a gamma correction circuit, a contour correction circuit, a luminance/color-difference signal generation circuit, and the like. The image signal processing circuit 78 performs a predetermined signal process while using the memory 38 in response to a command from the CPU 30.

The RGB image data is inputted to the image signal processing circuit 78 which converts the RGB image data to a luminance signal (Y signal) and a color-difference signal (Cr and Cb signals) and performs a predetermined process such as a gamma correction. The image data processed by the image signal processing circuit 78 is stored in the VRAM 40.

When the shot image is monitor-outputted to an image display apparatus 48, the image data is read from the VRAM 40 and fed into a video encoder 80 via the bus 32. The video encoder 80 converts the inputted image data to a signal in a predetermined system for display (e.g., color composite video signal according to the NTSC system) and outputs the signal to the image display apparatus 48.

In response to an image signal outputted from the CCD 50, image data representing one frame of image is rewritten alternately between an area A 40A and an area B 40B of the VRAM 40. Of the area A 40A and the area B 40B of the VRAM 40, written image data is read from an area other than the area in which image data is rewritten. In this manner, image data is periodically rewritten in the VRAM 40. When a video signal generated from the image data is supplied to the image display apparatus 48, a video in shooting is displayed real-time on the image display apparatus 48. The shooter can confirm the shooting angle-of-view by a video image (through movie image) displayed on the image display apparatus 48.

When the shooting button 44 is half-pressed and S1 is turned on, the mobile terminal 3 starts the AE and AF processes. That is, the image signal outputted from the CCD 50 undergoes an A/D conversion and is then inputted to an AF detection circuit 82 and an AE/AWB detection circuit 84 through the image input controller 76.

The AE/AWB detection circuit 84 includes a circuit which divides one screen into a plurality of areas (e.g., 16×16) and integrates an RGB signal for each divided area and provides the CPU 30 with the integrated value. The CPU 30 detects an object brightness (object intensity) based on the integrated value obtained from the AE/AWB detection circuit 84 and calculates an exposure value (shooting EV value) suitable for shooting. According to the obtained exposure value and a predetermined program chart, the diaphragm value and the shutter speed are determined, based on which the CPU 30 obtains an appropriate amount of light exposure by controlling the electronic shutter and the iris of the CCD 50.

At automatic white balance adjustment, the AE/AWB detection circuit 84 calculates an average integrated value of each color of the RGB signals for each divided area and provides the CPU 30 with the calculated result. The CPU 30 obtains an integrated value of R, an integrated value of B, and an integrated value of G, and calculates a ratio of RIG and a ratio of B/G for each divided area. The CPU 30 determines the light source type based on the distribution of the values of R/G and B/G in the color space of R/G and B/G. According to the white balance adjustment value appropriate for the determined light source type, the CPU 30 sets the value of each ratio, for example, so as to be about 1 (i.e., the integration ratio of RGB in one screen is R:G:B≈1:1:1). Accordingly, the CPU 30 controls the gain value (white balance correction value) to the R, G, and B signals of the white balance adjustment circuit and corrects the signal of each color channel.

Contrast AF for moving a focusing lens (a moving lens contributing to focus adjustment, of a lens optical system constituting a shooting lens 62) is applied to the AF control of the mobile terminal 3, for example, so that the high-frequency component of the G signal of the video signal becomes a local maximum. That is, the AF detection circuit 82 includes a high-pass filter passing only the high-frequency component of the G signal; an absolute value processing unit; an AF area extraction unit extracting a signal in a focus object area preliminarily set in a screen (e.g., central portion of the screen); and an integration unit integrating absolute value data in the AF area.

Data of the integrated value obtained by the AF detection circuit 82 is fed into the CPU 30. While moving the focusing lens by controlling the lens drive unit 66, the CPU 30 calculates a focus evaluation value (AF evaluation value) at a plurality of AF detection points and determines the lens position in which the evaluation value becomes a local maximum, as the focusing position. Then, the CPU 30 controls the lens drive unit 66 to cause the focusing lens to move to the calculated focusing position. Note that calculation of the AF evaluation value is not limited to the embodiment of using the G signal, but the luminance signal (Y signal) may be used.

When the shooting button 44 is half-pressed and S1 is turned on, the AE/AF process starts. When the shooting button 44 is fully-pressed and S2 is turned on, a shooting operation for recording starts. The image data acquired accordingly when S2 is turned on is converted to a luminance/color-difference signal (Y/C signal) by the image signal processing circuit 78. The luminance/color-difference signal undergoes a predetermined process such as gamma correction and then is stored in the memory 38. The Y/C signal stored in the memory 38 is compressed in a predetermined format by the compression/expansion circuit 86 and then can be recorded in a memory card 100 through a card reader/writer 22. For example, a still image is recorded in a JPEG (Joint Photographic Experts Group) format.

When the reproduction mode is selected by the mode selection switch 42, compressed data of a final image file (last recorded file) recorded in the memory card 100 is read. When the last recorded file is a still image file, the read compressed image data is expanded to uncompressed YC signals through the compression/expansion circuit 86, converted to display signals through the image signal processing circuit 78 and a video encoder 80, and then outputted to the image display apparatus 48. Thereby, the image content of the file is displayed on a screen of the image display apparatus 48.

While one frame of a still image is being reproduced (including the reproduction of a leading frame of a moving picture), the file to be reproduced can be switched (between forward frame advance and reverse frame advance) by operating the right key or the left key of the cross-shaped key. An image file at the frame-advanced position is read from the memory card 100, and in the same manner as above, a still image or a moving picture is reproduced and displayed on the image display apparatus 48.

The camera-equipped mobile terminal 3 includes a microphone 12 which inputs a transmitting voice; a speaker 14 which outputs a received voice; a voice processing unit 26 which encodes the voice inputted from the microphone 12 and decodes the received voice; and a communication circuit 15 which communicates voice, images, and other data with the server 1, the PC 2, or other mobile terminal 3 through a mobile communication network.

The camera-equipped mobile terminal 3 can be configured of a well known camera-equipped mobile phone, a camera-equipped PDA (Personal Digital Assistance), or the like. Note that a circuit related to voice communication may not be needed.

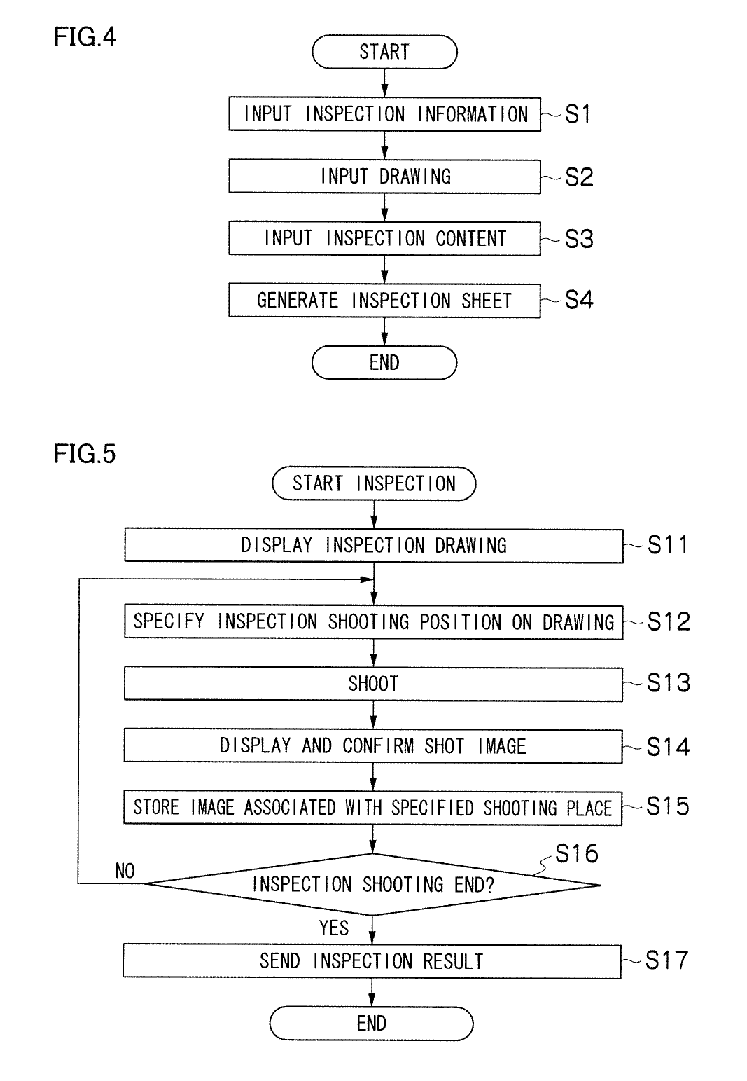

FIG. 4 illustrates a flowchart of an inspection sheet generation process. When the URL (Uniform Resource Locator) of the server 1 is specified on a web browser, the PC 2 accesses the server 1 and sends user account information (a combination of ID and password, etc.) to the server 1. The server 1 matches the received user account information with the certified user account information preliminarily stored in the DB 1a and, based on the matched result, the server 1 authenticates the PC 2. After the authentication completes, the server 1 starts this process in response to an instruction to the PC 2 (when a dedicated button icon is pressed or the like). The programs for causing the server 1 and the PC 2 to execute this process are stored in a storage medium of the server 1 and the PC 2.

In step S1, the server 1 sends an inspection information input screen to the PC 2. The PC 2 displays the screen received from the server 1 and accepts an input of inspection information in accordance with instructions on the screen. The inspection information may be inputted in any form such as text input by a key board or other operation apparatus and item selection from a list box.

For example, in the case of arbitrary point inspection, “utility pole number **”, the inspection type “crack inspection”, and the like can be inputted as the inspection information. In the case of fixed-point inspection, the construction object name “AA building”, the inspection type “reinforcement inspection”, the inspection place “3F”, the inspection object member “pillar”, the inspection points “1”, . . . , “9” and the like may be inputted as the inspection information. The PC 2 temporarily stores, in the RAM, inspection information inputted from the operation apparatus. A plurality of inspection object members can be inputted. It can be arbitrarily selected from the operation device of the PC 2 whether to generate an inspection sheet for arbitrary point inspection or to generate an inspection sheet for fixed-point inspection.

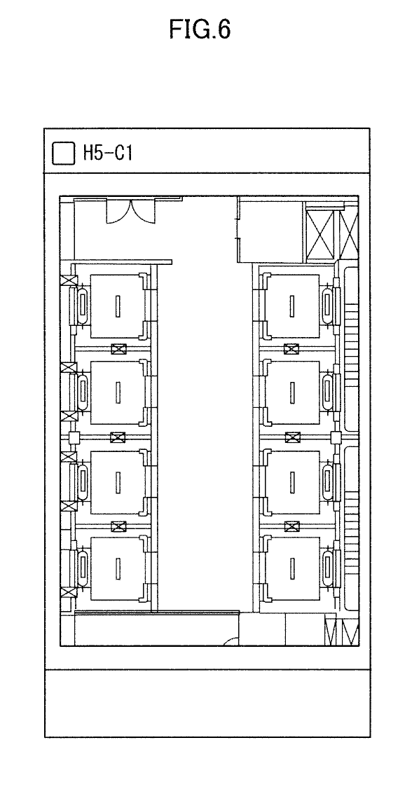

In step S2, the PC 2 accepts an input of an inspection drawing in response to an instruction of the screen. The inspection drawing as illustrated in FIG. 6 is an output from a CAD application operating on the PC 2 or other drawings conforming to various standards such as a PDF (Portable Document Format) and a jpeg image. Alternatively, the PC 2 may accept a selection of a desired drawing file from the drawings stored in the PC 2 and the selected drawing file may be used as the inspection drawing. The PC 2 temporarily stores the inputted inspection drawing in the RAM.

Moreover, in the case of fixed-point inspection, the PC 2 accepts an input of member-related information regarding the inspection object member inputted in step S1. The member-related information is information specifying a position on an individual member drawing corresponding to the inspection object member and a sketch drawing containing the inspection object member. That is, each inspection object member has its own specific installation position on the sketch drawing and its own specific structure. Therefore, this step reserves member-related information including position information indicating the installation position of each inspection object member on the sketch drawing and a member drawing which is information specifying the structure of each inspection object member.

In step S3, the PC 2 accepts an input of inspection content in response to an instruction of the screen. The inspection content is information specifically indicating which item or content is to be checked in this inspection and can be in any data format and form. Examples in the case of fixed-point inspection include text data containing characters such as “type”, “number”, and “pitch”; graphic data of a check box associated with the text data; and a drawing file of a sectional drawing. The PC 2 temporarily stores the inputted inspection content in the RAM.

In step S4, the PC 2 associates the inspection information and the inspection drawing temporarily stored in the RAM and sends the associated inspection data to the server 1. In the case of fixed-point inspection, the PC 2 can send not only the above data but also the inspection data including the member-related information and the inspection content to the server 1.

The server 1 generates an inspection sheet based on the inspection data which received from the PC 2. Specifically, first, the server 1 reads a template preliminarily stored in the inspection information DB 1a based on the inputted inspection information. For example, from the information on the inspection type “reinforcement inspection” and the inspection object member “pillar”, the server 1 reads “template for pillar reinforcement inspection” from the inspection information DB 1a. Alternatively, from the information on the inspection type “utility pole inspection”, the server 1 reads “template for utility pole inspection” from the inspection information DB 1a.

The template specifies the arrangement pattern and the display format of the inspection information and the inspection drawing.

In the case of fixed-point inspection, the template enables a markup language such as XML to be used to specify: first link information which enables the construction object name, the inspection type, the inspection place, and the framing plan contained in the inspection information to refer to each other; second link information which enables the member drawing (sectional drawing) corresponding to each inspection object member contained in the inspection information and position information of each inspection object member on the framing plan to refer to each other; third link information which enables respective inspection object members and the inspection results thereof to refer to each other; and fourth link information which enables a plurality of inspection photos corresponding to the same inspection place to refer to each other.

In the case of arbitrary point inspection, the template enables a markup language such as XML to be used to specify: first link information which enables the construction object name, the inspection type (arbitrary items), and the framing plan contained in the inspection information to refer to each other; second link information which enables the framing plan and position information of an inspection object arbitrarily set on the framing plan to refer to each other; third link information which enables respective inspection objects and the inspection results thereof to refer to each other; and fourth link information which enables a plurality of inspection photos corresponding to the same inspection place to refer to each other.

Note that unlike the inspection sheet, no value of inspection data is set in the template. Moreover, unlike the inspection report, no value of inspection result and inspection photo is set in the template.

The server 1 generates the inspection sheet by filling unfilled inspection information and inspection drawing in the read template with the inspection information and inspection drawing received from the PC 2.

The sketch drawing is filled in a position in which the sketch drawing is arranged in the template. If the size is not matched, the sketch drawing is scaled up or down or cropped in arbitrary range until the drawing fits in place.

When the member drawing has been inputted, based on the position information on the sketch drawing corresponding to each member drawing, the position information on each inspection object member on the sketch drawing is filled in the template. The position information is expressed by XY coordinate information on the sketch drawing or alternative information such as a baseline number.

The inspection content is also filled in a position in which the inspection content is arranged in the template. However, if the inspection content is contained in the member drawing, this process can be omitted.

The server 1 stores the generated inspection sheet in the DB 1a.

Note that program for performing the above generation procedure may be executed not by the server 1, but by the PC 2. Instead of the server 1, the PC 2 may generate the inspection sheet. If the template is in the server 1, the PC 2 requests the server 1 to send the template. When the template is received, the PC 2 fills the inputted inspection information and the like in the template. The inspection sheet generated by the PC 2 is sent to the server 1 and is stored in the DB 1a.

Then, the server 1 treats the template with inspection data (inspection information and inspection drawing) filled therein as the inspection sheet.

The layout of the inspection information and the inspection drawing may be arbitrarily specified in the template, and the display layout for the mobile terminal 3 and the print layout for the printer 4 connected to the PC 2 may also be specified in the template. Alternatively, the display layout for the mobile terminal 3 and the print layout for the printer 4 may be determined by an application of the mobile terminal 3 or the printer 4 respectively.

For the purpose of allowing the user to confirm the content of the generated inspection sheet (without inspection result filled therein), the server 1 may convert the generated inspection sheet to print data printable by the printer 4 to output the print data to the printer 4 and instruct the printer 4 to print the inspection sheet.

Moreover, the server 1 may allow the content of the generated inspection sheet to be viewed by a user of the PC 2 or the mobile terminal 3 who is logged on to the server 1 under an account of administrator privileges such as a construction site supervisor; as well as the server 1 may accept an input of acknowledgment or no acknowledgment and the server 1 may be configured such that if acknowledgment is inputted, the inspection sheet is stored in the DB 1a and if no acknowledgment is inputted, the inspection sheet is not stored in the DB 1a.

FIG. 5 illustrates a flowchart of an inspection work process. The programs for causing the server 1 and the mobile terminal 3 to execute this process are stored in a storage medium of the server 1 and the mobile terminal 3 respectively.

In step S11, the user logs in from the mobile terminal 3 to the server 1 under inspector privileges and instructs the start of the inspection process. At this time, it is assumed that the inspector carries the mobile terminal 3 to the inspection site. When an instruction to start the inspection process is received from the mobile terminal 3, the server 1 opens an inspection sheet stored in the DB 1a and sends the inspection sheet to the mobile terminal 3. If a plurality of inspection sheets is stored in the DB 1a, the server 1 sends the inspection sheet selected from the mobile terminal 3. Alternatively, the server 1 associates the inspection sheet with the inspection implementation date before storing the inspection sheet in the DB 1a and sends, to the mobile terminal 3, the inspection sheet corresponding to the same or most recent inspection implementation date when an instruction to start the inspection process is received from the mobile terminal 3.

Moreover, the server 1 may add the name of a logged-in inspector and the inspection date to the inspection information to be filled in the inspection sheet. The inspection date may be replaced with the access date, and the name of the inspector may be replaced with the name of a logged-in user.

The server 1 can receive various data from the mobile terminal 3 and associate the data with the opened inspection sheet before storing the inspection sheet in the DB 1a. Data may be sent from the mobile terminal 3 to the server 1 at any timing, such as each time the data is inputted from the mobile terminal 3, or data may be sent collectively at a specific timing such as when the inspection process ends.

The mobile terminal 3 stores the inspection sheet received from the server 1 in a storage medium such as a memory 38, converts the image data of the stored inspection sheet to a video signal, and displays the image on the image display apparatus 48. The inspection sheet may be displayed in any manner. For example, in the case of fixed-point inspection, the inspection sheet may be displayed on a viewer screen displaying a framing plan (see FIG. 6) in which an installation position of each inspection object member is displayed; or the inspection sheet may be displayed on a list screen on which inspection points are listed item by item; or further, the inspection sheet may be displayed on the viewer screen or the list screen alternately switched in response to an instruction to the operation apparatus.

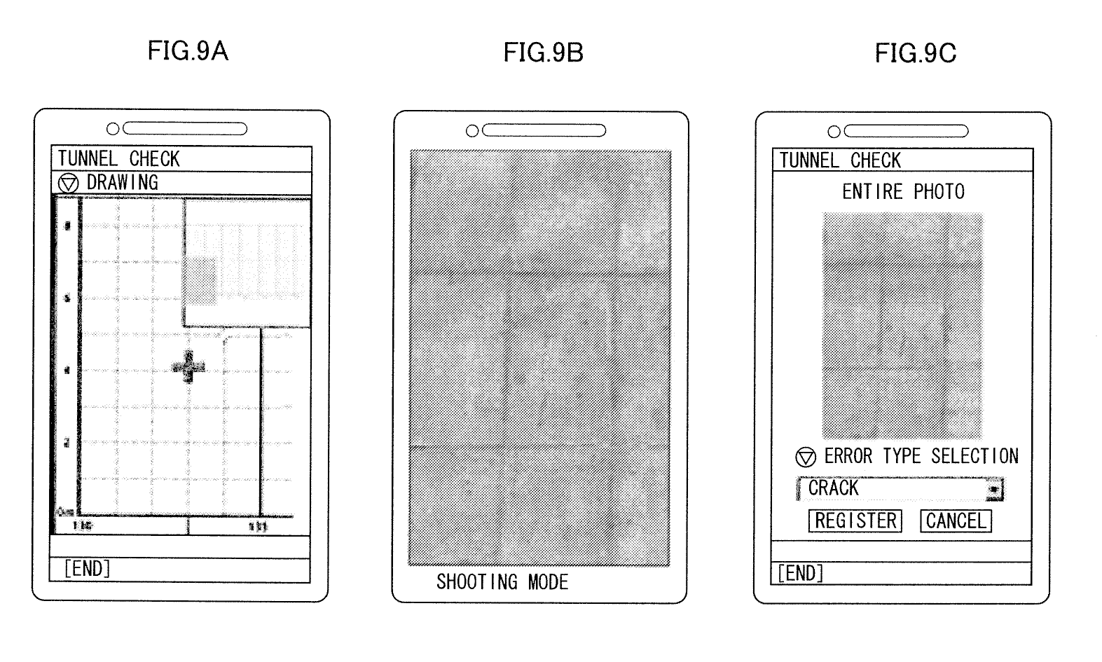

In the case of arbitrary point inspection, a viewer screen scalably (enlarged or reduced) displaying an entire inspection object drawing (see FIGS. 9A to 9C) is preferable.

In step S12, the mobile terminal 3 accepts a selection of the position of a desired inspection object member from the framing plan displayed on the image display apparatus 48. The selection may be made in any manner.

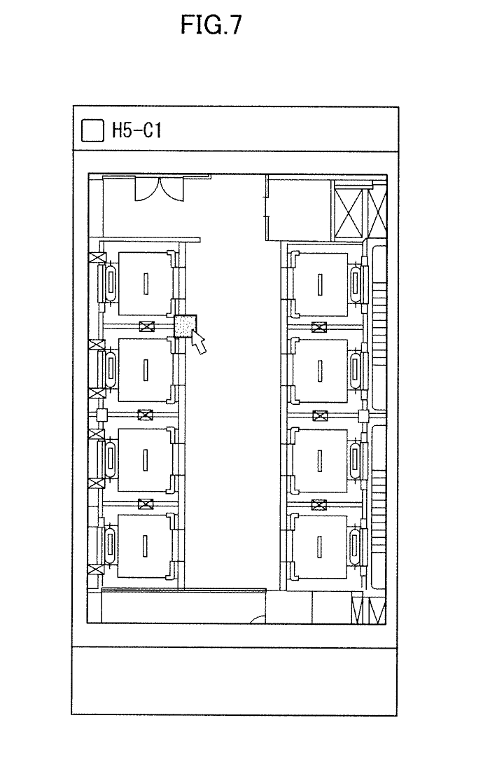

In the case of fixed-point inspection, the mobile terminal 3 operates such that an inspection object member arranged on the framing plan is indicated with a mark such as a rectangular in response to the pressing of a cross-shaped key of the operation device 46; the cursor moves between the marks; and when the OK key is pressed at a desired cursor position, the inspection object member located at the cursor position is accordingly selected (FIG. 7). Alternatively, when a numeric key corresponding to each inspection object member arranged on the framing plan is pressed, the inspection object member may be selected. Still alternatively, from among the positions in which inspection object members are located on the framing plan, when a position in which a desired inspection object member is located is touch-specified, the inspection object member may be selected. Note that a mark may be arranged in the touch-specified position so as to move the cursor.

In the case of fixed-point inspection, the inspection object member may be selected in any order from a plurality of inspection object members, but the order of selecting inspection object members may be preliminarily included in the inspection information, and only the selection according to the order may be accepted.

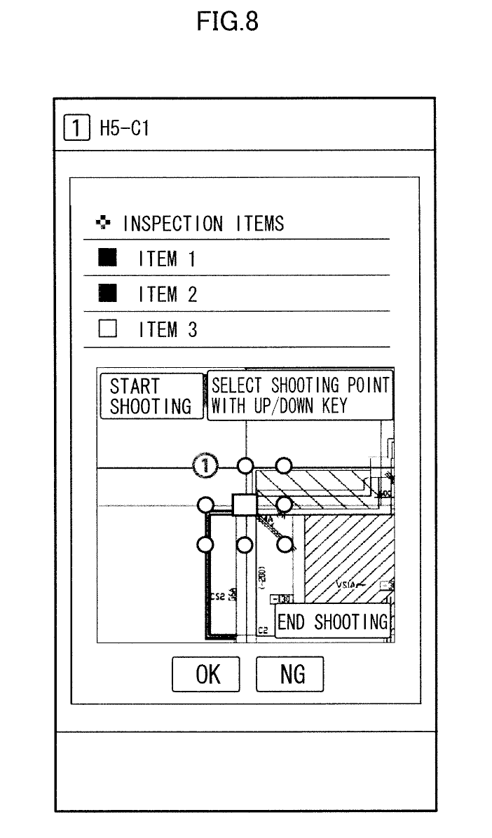

In the case of fixed-point inspection, the mobile terminal 3 displays the inspection content and the member drawing corresponding to the selected inspection object member on the image display apparatus 48. FIG. 8 is an example of the display screen. On this screen, a sectional drawing illustrating a pillar member is displayed together with specific inspection items (the type, the number, and the pitch of the member). In addition, for each inspection item, a check box is displayed to allow OK or NG to be inputted as the inspection result for the inspection item. Moreover, the cursor can be set with cross-shaped key of the operation device 46 to a pattern of inspection points corresponding to the selected inspection object member, such as any one of the inspection points 1 to 9 each indicating a shooting direction as viewing the pillar from the circumference of the horizontal section of the pillar or the inspection points can be selected in response to the pressing operation at display positions of the inspection points on a touch panel 13. The inspection points are not limited to the illustrated inspection points. For example, if the inspection object member is a wall, a desired surface can be selected from the three surfaces of the wall: the left-side surface, the central surface, and the right-side surface. The inspection points may be displayed with different colors each indicating the points which have been inspected, the points which are not inspected, and the points which are being inspected. For example, the points which have been inspected are displayed in blue, the points which are not inspected are displayed in red, and the points which are being inspected are displayed in yellow.

In the case of fixed-point inspection, the mobile terminal 3 accepts a selection of an inspection point “1” and an input of the inspection result through the operation device 46. The screen in FIG. 8 can accept a selection input of an inspection point and an input of a check indicating whether the inspection item such as the type, the number, and the pitch of the member is OK or NG. In addition, the inspection result may be inputted as text from the operation apparatus, or a voice memo function of the mobile terminal 3 may be used to input the content of the inspection result or the repair instruction with a spoken voice of the inspector.

Meanwhile, in the case of arbitrary point inspection, the mobile terminal 3 specifies the inspection point (inspection object point) by specifying any point on the entire drawing by cursor specification or tap specification (see FIG. 9A).

In step S13, the mobile terminal 3 accepts an instruction to shoot an image assuming the current state of the inspection object viewed from the selected or specified inspection point as the object to be shot through the shooting button 44. Then, in response to the shooting instruction, the mobile terminal 3 starts shooting and stores the shot image or the inspection photo in the memory 38.

In step S14, the mobile terminal 3 displays the obtained inspection photo on the image display apparatus 48 (see FIG. 9B).

In step S15, the mobile terminal 3 accepts an input of the inspection result. The inspection result includes the OK/NG decision of the inspection, the error type, and the like (see FIG. 9C). The mobile terminal 3 associates the inspection photo, the inspection sheet, the selected inspection object member (only in the case of fixed-point inspection) and the inspection point with each other and stores them in memory 38 again.

In step S16, the mobile terminal 3 determines whether or not all inspection photo shootings corresponding to all inspection object members are completed according to whether or not the mobile terminal 3 accepts an acknowledgment input indicating whether or not the inputs of inspection results and the shootings of the inspection photos corresponding to all inspection object members are completed through the operation device 46. If a determination is made Yes, the process moves to step S17. If a determination is made No, the process returns to step S12, in which the inspection result and the inspection photo corresponding to each inspection point are obtained by repeating inputting the inspection result corresponding to the selected or specified inspection point and shooting the inspection photo.

In step S17, the mobile terminal 3 associates the inspection result and the inspection photo of each inspection point stored in the memory 38 with the user ID of the mobile terminal 3 and sends them to the server 1. When the inspection result and the inspection photo are received, the server 1 stores the received inspection result information associating the inspection result and the inspection photo of each inspection point with the user ID in the DB 1a.

The mobile terminal 3 displays the inspection result at each inspection point on the image display apparatus 48. The inspection result may be displayed in any format. Note that FIG. 5 illustrates the inspection result display process as step S14, but this process may be performed at any timing after the inspection starts. For example, the inspection result can be displayed each time an inspection photo shooting is completed at each inspection point. Alternatively, the status of inspection results completed up to now may be list-displayed in response to an instruction from the user. At this time, if there is an inspection object member the inspection result of which is not inputted and to which a shooting of the inspection photo is not completed, the mobile terminal 3 can specify the inspection point and display a text message on the display screen or give a voice message, indicating that the inspection is not completed at the specified inspection point, thereby preventing inspection omission.

Alternatively, upon completion of the shootings of the inspection photos corresponding to all inspection object members, the mobile terminal 3 may send a mail message informing the preliminarily set communication partners (the server 1, the PC 2, and other mobile terminals 3) of a completion of the inspection. In particular, if an NG is inputted as the inspection result to an object member, the mobile terminal 3 may send a repair instruction, together with a set of the object member, the inspection point, the inspection result content, and the inspection photo corresponding to the inspection result of the NG, to the mobile terminal 3 and the PC 2 of a person in charge of the construction preliminarily specified by the operation device 46, with an email or other data communication.

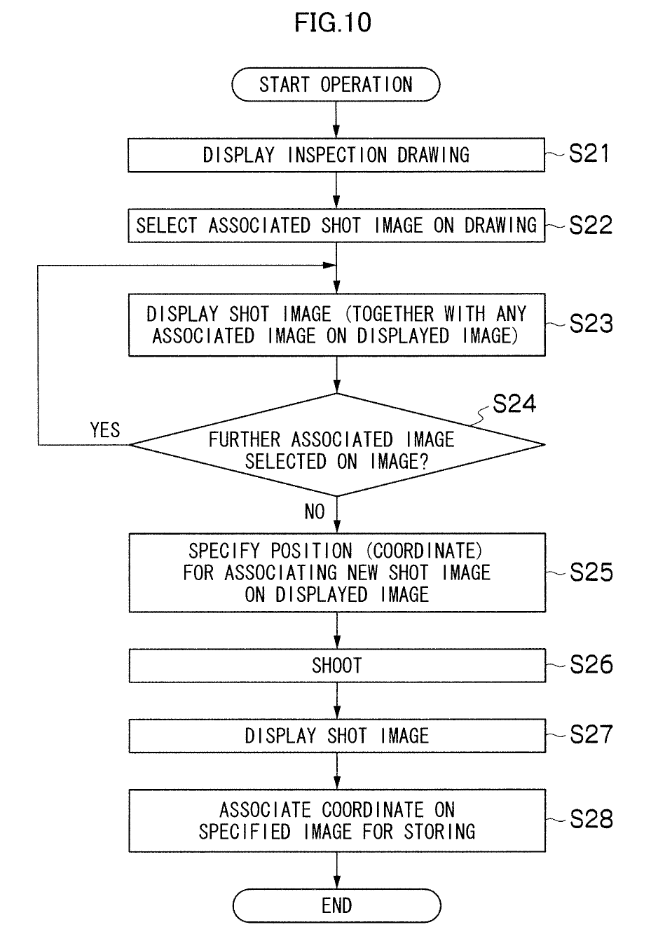

FIG. 10 illustrates a flowchart of an inspection photo association process. The programs for causing the server 1 and the mobile terminal 3 to execute this process are stored in a storage medium (ROM 34, inspection information DB 1a, etc.) of the server 1 and the mobile terminal 3. This process is performed following the process in FIG. 5.

In step S21, in response to an instruction inputted to the operation device 46, the mobile terminal 3 displays the viewer screen on the image display apparatus 48 so as to display the framing plan, the shot member of the inspection photo (only in the case of fixed-point inspection) and the inspection point stored in the memory 38.

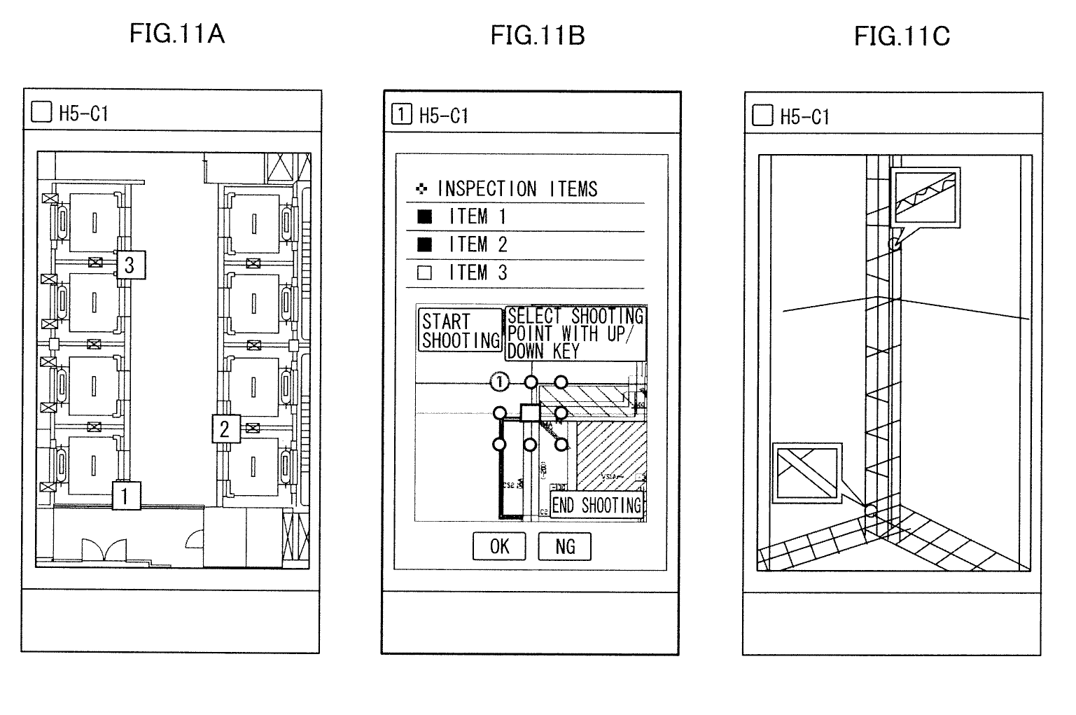

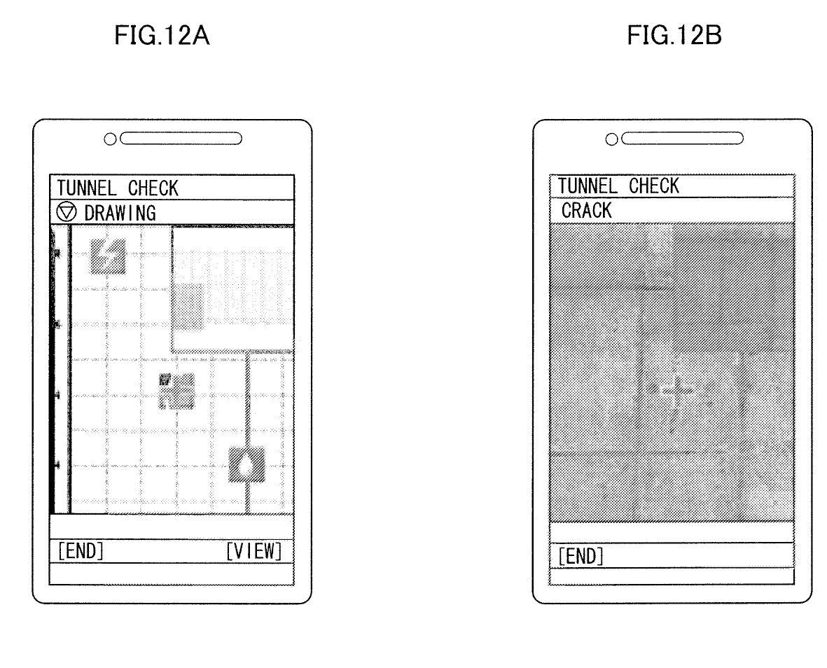

FIG. 11A illustrates an example of a viewer screen for fixed-point inspection. FIG. 12A illustrates an example of an inspection point selection screen serving also as the viewer screen for arbitrary point inspection. If the memory 38 does not have inspection information such as a framing plan nor inspection result information such as an inspection photo, the inspection information or the inspection result information is acquired from the DB 1a of the server 1, stored in the memory 38, and then displayed. Arbitrary inspection photo may be displayed. A post-view image before being stored in the memory card 100 or an image whose compressed image is expanded in the memory 38 after being stored in the memory card 100 may be displayed.

In step S22, the mobile terminal 3 accepts a selection of a desired shot member and inspection point on the framing plan. FIG. 11B is an example of an inspection point selection screen for fixed-point inspection. FIG. 12A illustrates an example of the inspection point selection screen serving also as the viewer screen for arbitrary point inspection. The mobile terminal 3 reads the inspection photo associated with the desired inspection point on the framing plan selected from the operation device 46 from the memory 38. Then, the mobile terminal 3 displays the read inspection photo itself or a list of identification information of an inspection photo substituting for the inspection photo on the image display apparatus 48. Note that the list of identification information of inspection photos can be configured to include an icon of each inspection photo, a thumbnail, a file name, a time stamp, or graphics modifying the same.

In step S23, the mobile terminal 3 accepts a selection of a desired inspection photo from a list of inspection photos associated with the inspection point through the operation device 46. In the description of this process, the selected inspection photo is referred to as “parent inspection photo”.

In step S24, the mobile terminal 3 determines whether or not an inspection photo (referred to as a “child inspection photo” in the description of this process) associated with a specific position of the parent inspection photo selected in step S23 is further stored as inspection result information in the memory 38. If a determination is made that an associated inspection photo is stored in the memory 38, the process returns to step S23, where the child inspection photo or substitute identification information (thumbnail, icon, etc.) is list-displayed together with the position information of the associated inspection photo on the image display apparatus 48.

Graphics such as a marker and a bubble can be used to indicate the relation between the specific position of the inspection point and the child inspection photo associated with the position or the identification information. If no child inspection photo is stored in the memory 38, the process moves to step S25. Note that association between the specific position of the inspection photo and the child inspection photo is performed in steps S25 to S28 described later.

FIG. 11C illustrates a display example of a thumbnail of the child inspection photo associated with the specific position of the parent inspection photo in the case of fixed-point inspection. FIG. 12B illustrates a display example of an icon of the child inspection photo associated with the specific position of the parent inspection photo in the case of arbitrary point inspection.

In step S25, the mobile terminal 3 displays the parent inspection photo selected in step S23 on the image display apparatus 48 and then accepts a specification of an association position, which is a desired position for associating the child inspection photo on the parent inspection photo through the operation device 46.

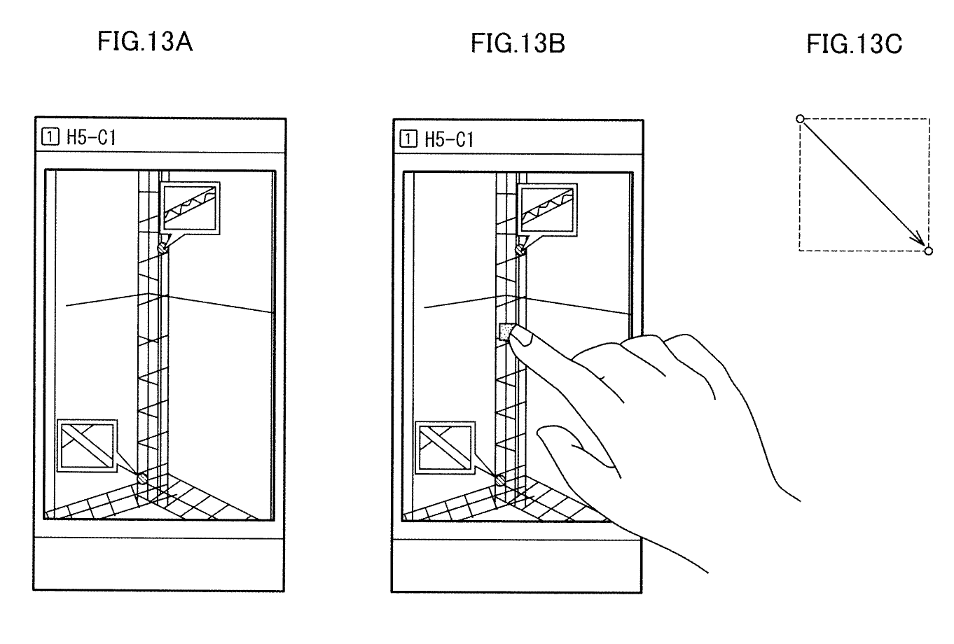

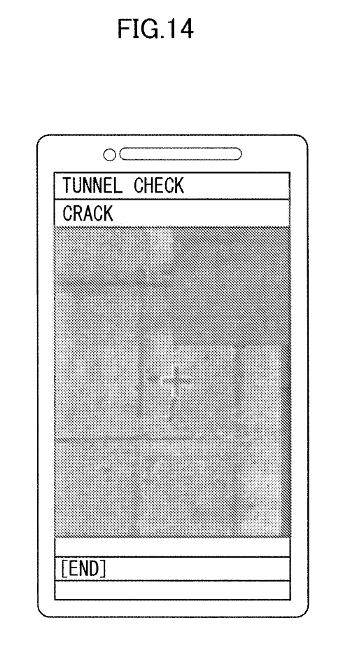

For example, the point coordinate of the association position is specified by moving the cursor to a desired point on the parent inspection photo as illustrated in FIG. 13A, or by single tapping on a desired point on the parent inspection photo as illustrated in FIGS. 13B and 14. When the association position is to be as a two-dimensional region such as when a partial region of the object of the parent inspection photo is to be set as the object of the child inspection photo, a diagonal line is specified by double tapping or by cursor clicks on two points or a rectangular region is specified by tap and drag (FIG. 13C). The rectangular region can be displayed by enclosing the region with a dotted line or making translucent inside the region. The difference between a point and a two-dimensional region can be clarified in such a manner that when the specified association position is a point, the point is displayed with a circle; and when the specified association position is a two-dimensional region, the region is displayed with a rectangular mark.

In step S26, the mobile terminal 3 accepts an instruction to shoot an image through the shooting button 44. Then, in response to the shooting instruction, the mobile terminal 3 starts shooting and stores the shot child inspection photo in the memory 38.

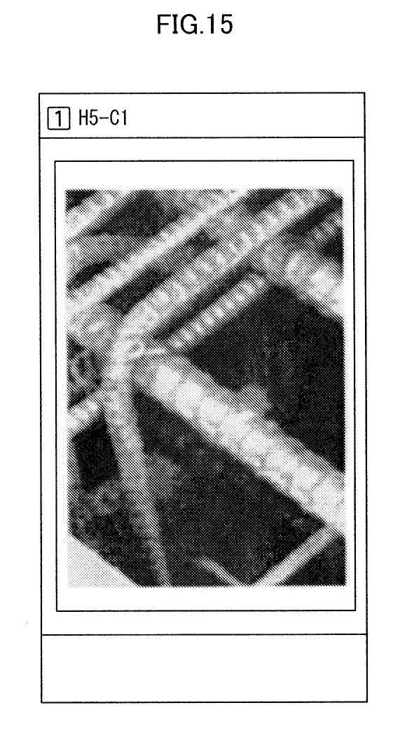

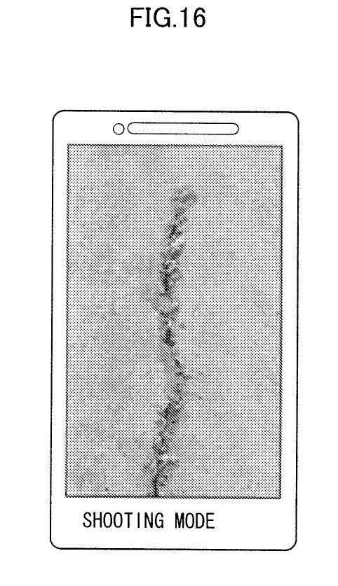

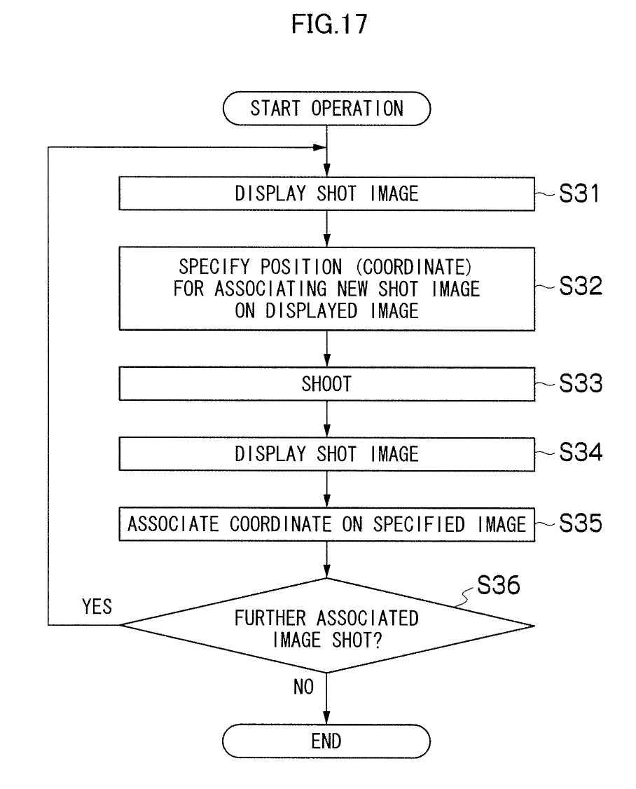

In step S27, the child inspection photo stored in the memory 38 is displayed on the image display apparatus 48. FIG. 15 is a display example of a child inspection photo for fixed-point inspection (reinforcement inspection). FIG. 16 is a display example of a child inspection photo for arbitrary point inspection.

In step S28, the mobile terminal 3 associates the child inspection photo stored in the memory 38 with the ID of a higher-level inspection photo specified in step S25, coordinate information (x, y) indicating the position on the higher-level inspection photo, and the shooting point ID uniquely allocated to the position, and then stores the associated child inspection photo in the memory 38 again. The above information can be associated by using a markup language such as XML or a relational table. Note that the child inspection photo can be further associated with the inspection result and stored.

The mobile terminal 3 sends the ID of the parent inspection photo, the child inspection photo (together with the ID of the child inspection photo), the position information, and the inspection result to the server 1 as the inspection result information. Note that when the camera-equipped mobile terminal 3 is located in a place where the mobile communication network is in a bad communication state such as in a construction site, the inspection result information may be sent by moving the camera-equipped mobile terminal 3 to a place in a good communication state. The inspection result information may be sent at any timing such as each time the inspection result is inputted, when all inspection routines complete processing, or according to the set schedule. The inspection result information may include the following information as an option.
Inspection profile information (site name, inspection type, inspection object member, floor, etc.)
Inspection implementation information (inspection implementation year/month/day, inspection start time, inspection end time, inspector name)
Drawings (plan view of the entire site, plan view of enlarged inspection object and its vicinity, framing plan, and other additional drawings)
Inspection point information (coordinate on the drawing, part number of the inspection member) for the number of inspection points
Inspection results corresponding to an inspection item (a set of inspection point ID, inspection item, failure type, error condition, member type, and the inspection result corresponding to the inspection item) for the number of inspection points
Shooting point information (shooting point ID, coordinate on the drawing, vertical/horizontal direction of the shooting point on the drawing, and shooting point information for the number of associations) for the number of inspection points
Associated image shooting point information (associated image ID, coordinate on the drawing (coordinate value of the point and coordinate value of the rectangular region), and associated image shooting point information for the number of associations)

Note that the inspection implementation information, the inspection result information, the inspection point information, and the associated image shooting point information are inputted to the mobile terminal 3 after the inspection starts.

FIG. 17 illustrates a flowchart of an inspection photo re-association process. The programs for causing the server 1 and the mobile terminal 3 to execute this process are stored in a storage medium (ROM 34, inspection information DB 1a, etc.) of the server 1 and the mobile terminal 3. This process starts after the process in FIG. 4 or 5 ends.

In step S31, the mobile terminal 3 displays a “child inspection photo” stored in the memory 38 in step S15 or S28 on the image display apparatus 48. An any child inspection photo may be displayed. A post-view image before being stored in the memory card 100 or an image whose compressed image is expanded in the memory 38 after being stored in the memory card 100 may be displayed.

In step S32, the mobile terminal 3 displays the child inspection photo displayed in step S31 on the image display apparatus 48, and then accepts a specification of a desired position for associating a lower-level inspection photo dependent on the child inspection photo through the operation device 46.

The S33 is the same as the S26. In the description limited to this process, the image shot here and stored in the memory 38 is referred to as a “grandchild inspection photo”.

In step S34, the grandchild inspection photo stored in the memory 38 is displayed on the image display apparatus 48.

In step S35, the mobile terminal 3 associates the grandchild inspection photo stored in the memory 38 with the position information indicating the position on the child inspection photo displayed in step S31 and stores the associated grandchild inspection photo in the memory 38 again. Then, the mobile terminal 3 sends the ID of this child inspection photo, the grandchild inspection photo (together with the ID of the grandchild inspection photo), and the position information to the server 1 as the inspection result information.

In step S36, the mobile terminal 3 accepts a selection of whether or not a further lower-level inspection photo is to be shot and associated with the grandchild inspection photo shot in step S33 through the operation device 46. If the mobile terminal 3 accepts a selection that the further lower-level inspection photo is to be shot, the process returns to step S31 and displays the lower-level inspection photo shot in step S34. If the mobile terminal 3 accepts a selection that the further lower-level inspection photo is not shot, this process ends. That is, another inspection photo can be hierarchically associated with a specific position of the existing inspection photo.

The above process can associate a desired position of a higher-level inspection photo with data of a lower-level inspection photo as well as can visually present the association between the higher-level inspection photo and lower-level inspection photo.

The server 1 may embed the inspection photo group associated with the inspection result information or the information substituting for these (hyper links indicating the respective storage places, etc.) in the template of the inspection sheet and then may store an inspection report which is the inspection sheet in which the inspection result information and the inspection photo group are embedded. For example, the server 1 may embed link information (described by URL, etc.) for accessing the inspection result information and the inspection photo group opened by a web server built in the server 1, in the template of the inspection sheet sent to the mobile terminal 3, and then may store the embedded inspection report.

Then, the server 1 outputs the stored inspection report outside through the printer 4, a display of the PC 2, or the image display apparatus 48 of the mobile terminal 3.

The inspection report may be outputted in any format. For example, the server 1 layouts the inspection sheet of XML (Extensible Markup Language) data reflecting the inspection result according to a predetermined layout conversion rule such as XSLT (Extensible Stylesheet Language Transformations) into a form format or a screen display format, converts the data to output data such as PDF, and then stores the output data. In response to a request from the PC 2, the server 1 sends the inspection report, which is the layouted output data, to the PC 2. When the inspection report is received from the server 1, the PC 2 prints the inspection report on the printer 4 or displays the inspection report on a display connected to the PC 2 or the image display apparatus 48 of the mobile terminal 3.

The items of a template, an inspection sheet, or an inspection report can be defined by XML tags. Examples of the defined items include: the inspection type of the fixed-point inspection or arbitrary inspection; the type of the drawing information including the original framing plan, the original sectional drawing, or the reduced image thereof; the width; the height; the file name; the storage path; the coordinates of the inspection point; the inspection result corresponding to each inspection point; the ID number of inspection photo shooting point; the XY coordinates; the shooting direction; the position information on the drawing information associated with the inspection photo and the file name of the inspection photo; the storage destination path of the inspection photo; the shooting date; and the like.

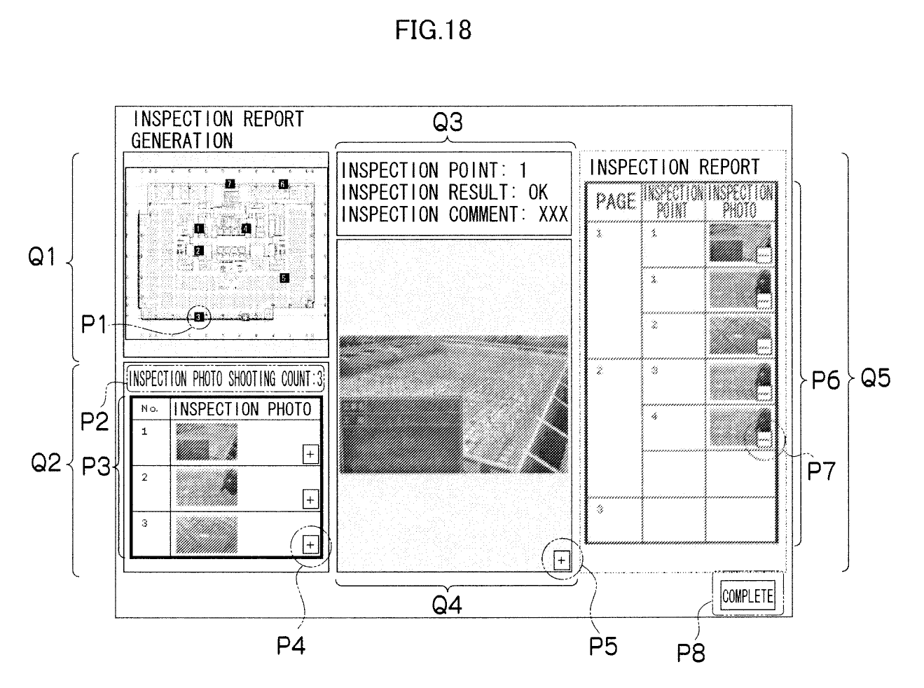

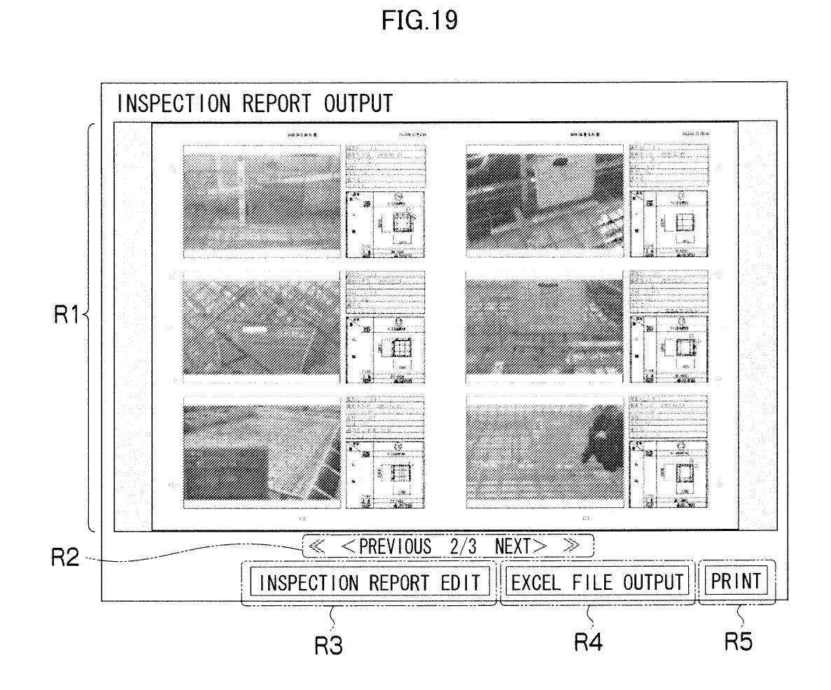

The value corresponding to each item defined in the inspection sheet is set according to the inspection result and the inspection photo acquired from the mobile terminal 3. The PC 2 displays a desired inspection place and the inspection photo and the inspection result corresponding to the inspection place based on the inspection sheet on the inspection report generation screen (see FIG. 18). The PC 2 generates an inspection report associating the inspection result such as a desired inspection comment and a desired inspection photo with a desired inspection place on a framing plan of the inspection sheet selected through the screen. The PC 2 accepts a file or a print output of the generated inspection report through the inspection report output screen (see FIG. 19).

FIG. 18 illustrates an example of an inspection report generation screen.

As illustrated in FIG. 18, the inspection report generation screen includes an inspection point selection area Q1, an inspection point icon P1, an all inspection photo display area Q2, an inspection photo shooting count display area P2, an inspection photo list P3, an Add button P4, an inspection point detail display area Q3, an inspection photo enlarged display area Q4, an Add/Delete button P5, an inspection report generation area Q5, a for-report inspection photo list P6, a Delete button P7, and a Complete button P8.

The inspection point selection area Q1 is an area in which the framing plan (inspection map) and one or more inspection points corresponding thereto contained in the inspection data are displayed by the inspection point icon P1 and a desired inspection point is selected by clicking or the like from the inspection points displayed by the inspection point icon P1 corresponding to the inspection point.

The all inspection photo display area Q2 is an area in which, of the inspection photos acquired from the mobile terminal 3, all inspection photos associated with the inspection point selected in the inspection point selection area Q1 are displayed.

The inspection photo shooting count display area P2 is an area in which the number of all inspection photos associated with the inspection point selected in the inspection point selection area Q1 is displayed.

The inspection photo list P3 is an area in which all inspection photos associated with the inspection point selected in the inspection point selection area Q1 are list-displayed.

The Add button P4 is a GUI (Graphic User Interface) for specifying an inspection photo to be included in or to be added to the inspection report, of the inspection photos displayed in the inspection photo list P3.

The inspection point detail display area Q3 is an area in which detail information associated with the inspection point selected in the inspection point selection area Q1 is displayed. The detail information can include inspection information such as an inspection point number contained in the inspection data, the inspection result and the comment acquired from the mobile terminal 3, and the like.

The inspection photo enlarged display area Q4 is an area in which the inspection photo selected in the all inspection photo display area Q2 and the inspection report generation area Q5 is displayed.

When the inspection photo selected in the all inspection photo display area Q2 is displayed, the Add/Delete button P5 is a GUI for adding the inspection photo to the inspection report. When the inspection photo selected in the inspection report generation area Q5 is displayed, the Add/Delete button P5 is a GUI for deleting the inspection photo from the inspection report.

The inspection report generation area Q5 is an area in which the inspection photo to be included in the inspection report is determined.

The for-report inspection photo list P6 is an area in which the inspection photos to be included in the inspection report are list-displayed.

The Delete button P7 is a button for deleting the inspection photo from the inspection report.

The Complete button P8 is a GUI for completing the generation of the inspection report and executing the registration and storage of the inspection report.

The user can select a desired inspection point, can select a desired inspection photo from all inspection photos corresponding to the selected inspection point, and can store the selected inspection photo and the inspection result corresponding to the inspection photo as the inspection report.

Conventionally, the user needs to select an inspection photo for the inspection report from a large number of inspection photos, and needs to manually perform a layout operation of associating the selected inspection photo with the inspection result using spread sheet software or the like. In contrast, the user can use this screen to select a desired inspection photo to be included in the inspection report from the inspection photos corresponding to a desired inspection point and can store the selected inspection photo, the inspection point information and the inspection result corresponding to the inspection photo as the inspection report.

FIG. 19 is an example of an inspection report output screen.

As illustrated in FIG. 19, the inspection report output screen includes an inspection report display area R1, a Paginate R2, an inspection report edit button R3, a file output button R4, and a print button R5. The inspection report display area R1 is an area in which the generated inspection report is displayed. The Paginate R2 is a GUI for accepting an instruction to display pagination when the generated inspection report extends beyond a page. The file output button R4 is a GUI for accepting an instruction to output the inspection report to a storage medium in a predetermined file format such as a spread sheet file format. At this time, a dialog box for specifying a file name and a file storage place is opened. A desired file name and file storage place can be specified in the dialog box. When storage is completed, editing the inspection report is disabled. The print button R5 is a GUI for accepting an instruction to execute printing of the inspection report.

As described above, the inspection system according to the present embodiment allows the inspector to specify a desired inspection point while viewing the framing plan and the member drawing included in the inspection sheet preliminarily generated by the PC 2 with the mobile terminal 3, shoot an inspection photo corresponding to the specified inspection point with the mobile terminal 3, and store the inspected inspection sheet, which is data associating the inspection point with the inspection photo, in the server 1. The inspected inspection sheet stored in the server 1 can be converted to a form format to be printed or displayed. Therefore, a series of inspection tasks such as inspection sheet generation, inspection result input, inspection photo shooting, and form output can be easily performed using the server 1, the PC 2, and the mobile terminal 3. In particular, inspection point input, inspection result input, and inspection photo shooting or re-shooting can be performed using the mobile terminal 3, and thus portability and operability at an inspection site are high.

### Second Embodiment

If a failure is found as a result of inspection, a request needs to be made to a contractor. When the request is sent together with the inspection result information to the contractor, the contractor can easily determine the failure and can quickly handle the failure.

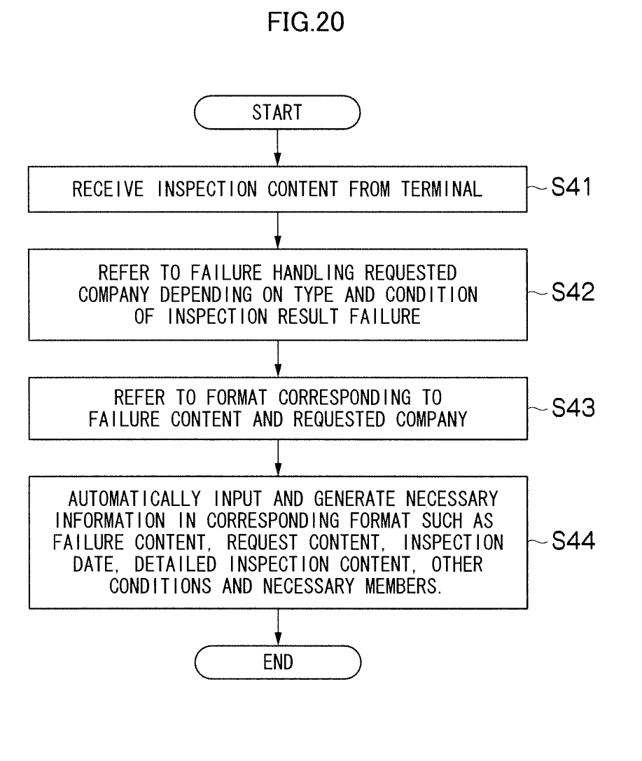

FIG. 20 is a flowchart of a failure handling request process. The programs for causing the server 1 and the mobile terminal 3 to execute this process are stored in a storage medium (ROM 34, inspection information DB 1a, etc.) of the server 1 and the mobile terminal 3.

In step S41, the server 1 receives inspection result information from the mobile terminal.

In step S42, the server 1 refers to a failure handling request table preliminarily stored in the DB 1a associating all or a part of the inspection result information with failure handling request information. Then, the server 1 determines the contractor's name who received the request to handle (hereinafter referred to as requested contractor's name) contained in the failure handling request information corresponding to the received inspection result information.

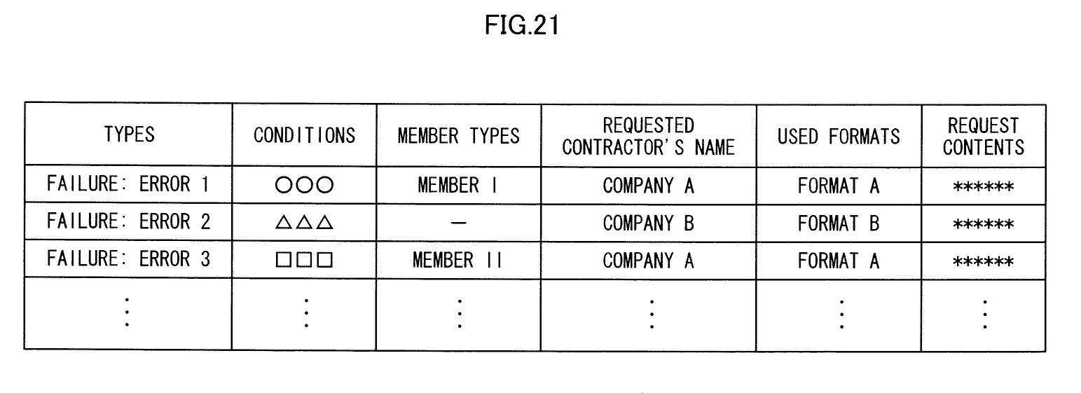

FIG. 21 is an example of a failure handling request table. In the failure handling request table, a possible pattern of the inspection result information (failure types, conditions, and member types) is associated with the failure handling request information (requested contracto's names, used formats, and request contents) of each pattern. This table shows the name of a company from which a failure handling is requested for each failure type, and the request format (document format). The table items are not limited to the listed items, but may be further simplified or refined. The table content can be freely added, updated, or deleted by a keyboard operation or the like of an authorized user.

In step S43, the server 1 determines the used format contained in the failure handling request information corresponding to the received inspection result information.

In step S44, the request information is generated such that the received inspection result information is arranged according to the format determined in step S43. The request information includes a member ID, an inspection point ID, and inspection photos (a higher-level inspection photo and a lower-level inspection photo) associated with the member ID and the inspection point ID, a failure content, a request content, an inspection date, a detailed inspection content, and the like.

The generated request information can be printed by the printer 4 or sent to a personal computer identified by the requested contracto's name (or substitute information such as a mail address) via a network.

In the present embodiment, the above description is given on an example of a construction inspection system for performing construction inspection work in a construction site using mobile phones, but the presently disclosed subject matter is not limited to the construction inspection system. For example, the presently disclosed subject matter can also be applied to a check system for a plant inspection, a dam inspection, a bridge pier inspection, and the like.

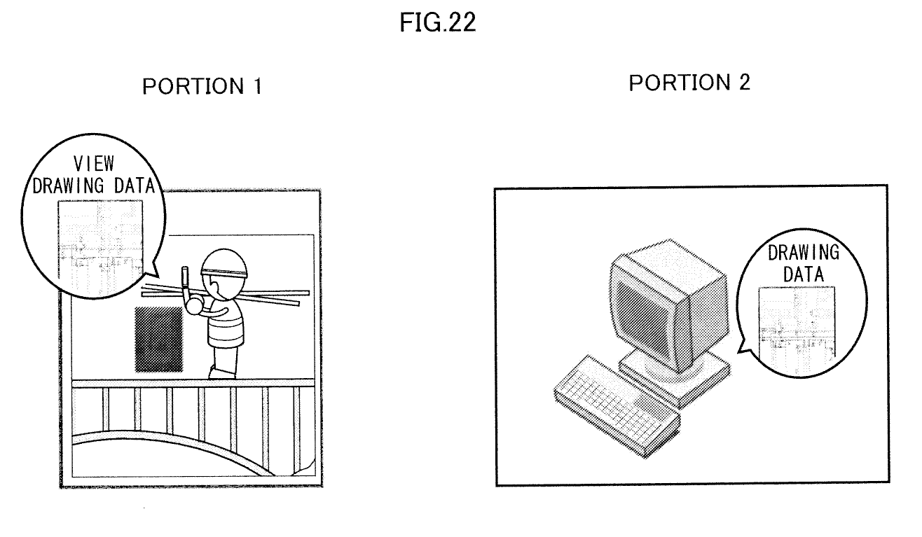

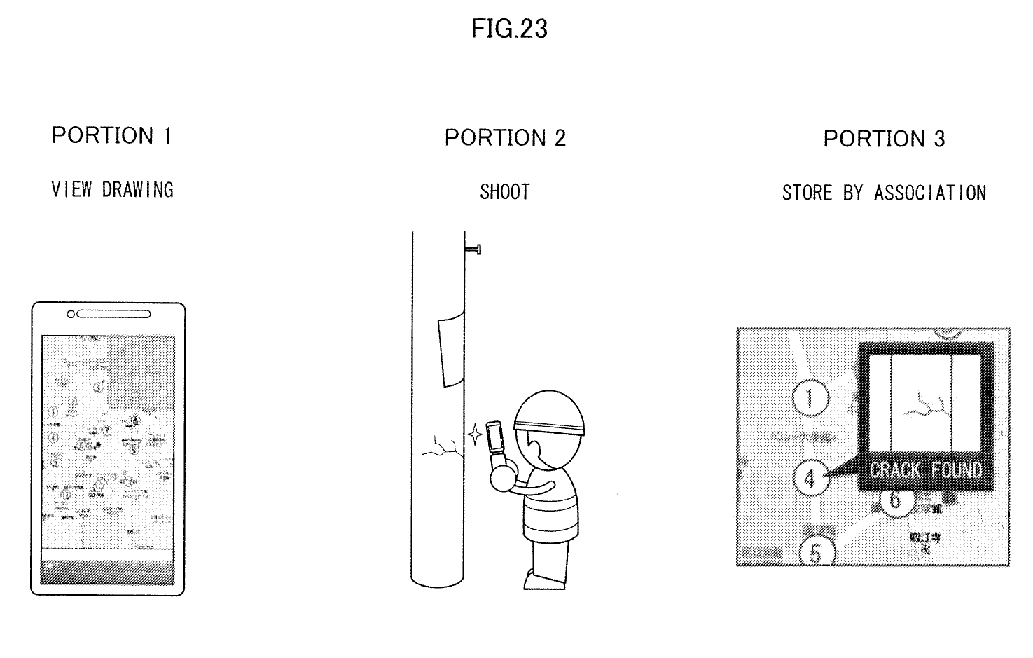

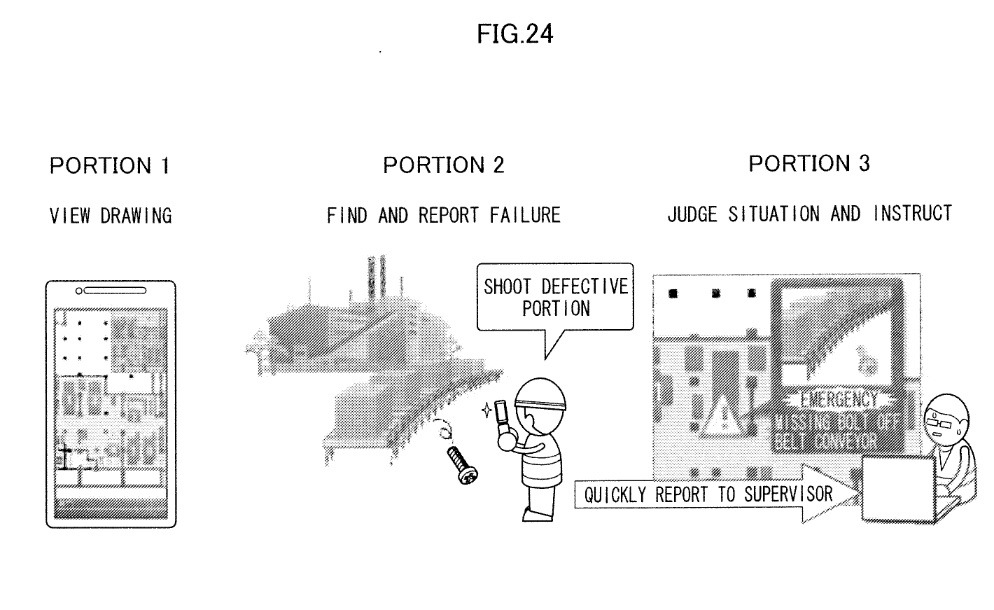

Further, the present inspection system can be used in a wide range of applications such as confirmation of a drawing at inspection in a construction site (see FIG. 22), inspection and maintenance of a utility pole (see FIG. 23), and inspection and maintenance of a plant (see FIG. 24). In FIG. 22, Portion 1 shows a personnel in a construction site browsing a drawing using a mobile terminal via a network to confirm the drawing, and Portion 2 shows a server in an office and so on transmits the drawing according to a request from the personnel in the construction site. In FIG. 23, Portion 1 shows a map indicating a location of a utility pole to be inspected, Portion 2 illustrates that a maintenance personnel arrived at the location according to the map is taking a photo of the utility pole, and Portion 3 shows a map in which a photo of inspection result is associated with the location of the utility pole (with an alert of cracking). In FIG. 24, Portion 1 shows a map indicating a location of a plant to be inspected, Portion 2 illustrates that a maintenance personnel arrived at the plant according to the map takes a photo of a defective or broken part in the plant and transmits the photo to another personnel in an office, and Portion 3 illustrates that the personnel (supervisor) in the office learns the trouble in the plant to see a sketch of the plant in which the photo of the broken part is associated with the location of the broken part (with an emergency alert of missing bolt off from a belt conveyer), thereby the personnel in the site can immediately notify the supervisor of the trouble in the plant. Moreover, the presently disclosed subject matter can be applied to various inspection systems including servers and mobile phones.

The presently disclosed subject matter includes a computer-readable medium having an encoded computer program, the program including computer-executable instructions for controlling a mobile terminal to execute the inspection method and so on according to the embodiments.

What is claimed is:

1. An inspection system comprising:
an inspection sheet generation apparatus and a mobile terminal, wherein
the inspection sheet generation apparatus comprises:
an inspection information input unit which inputs inspection information on an inspection object and drawing information on the inspection information; and
an inspection sheet generation unit which generates an inspection sheet based on the inspection information and the drawing information inputted by the inspection information input unit, and
the mobile terminal comprises:
a display unit which displays the inspection information and the drawing information based on the inspection sheet generated by the inspection sheet generation unit;
an inspection result input unit which inputs an inspection result corresponding to the inspection object;
a shooting point input unit which inputs a shooting point of the inspection object;
a shooting unit which can shoot a plurality of images including a first image and a second image assuming the inspection object as an object to be shot;
an association position specifying unit which specifies an association position, which is a position to be associated with the second image, of desired positions on the first image shot by the shooting unit; and
a storage unit which stores inspection result data associating the first image and the second image with the inspection result inputted by the inspection result input unit, the shooting point inputted by the shooting point input unit, and the association position specified by the association position specifying unit.

2. The inspection system according to claim 1, further comprising
a transmission unit which sends inspection result data stored in the storage unit to a predetermined server.

3. The inspection system according to claim 2, wherein the server comprises:
a table storage unit which stores a table associating an inspection result content and a failure handling request form;
a receiving unit which receives the inspection result data; and
a generation unit which determines a form corresponding to an inspection result indicated by inspection result data received by the receiving unit and generates failure handling request information based on the determined form and the inspection result data.

4. The inspection system according to claim 1, wherein the association position includes a vertical and/or horizontal shooting direction of the second image in the first image.

5. A mobile terminal comprising:
a display unit which displays inspection information and drawing information based on an inspection sheet containing inspection information on an inspection object and drawing information on the inspection information;
an inspection result input unit which inputs an inspection result corresponding to the inspection object;
a shooting point input unit which inputs a shooting point of the inspection object;
a shooting unit which can shoot a plurality of images including a first image and a second image assuming the inspection object as an object to be shot;
an association position specifying unit which specifies an association position, which is a position to be associated with the second image, of desired positions on the first image shot by the shooting unit; and
a storage unit which stores inspection result data associating the first image and the second image with the inspection result inputted by the inspection result input unit, the shooting point inputted by the shooting point input unit, and the association position specified by the association position specifying unit.

6. The mobile terminal according to claim 5, wherein the display unit associates the association position of the first image with the second image based on the inspection result data stored in the storage unit for displaying.

7. The mobile terminal according to claim 5, wherein the shooting point input unit selects position information of a desired inspection place from a plurality of predetermined inspection places on the drawing information.

8. The mobile terminal according to claim 5, wherein the shooting point input unit inputs position information of arbitrary inspection place on the drawing information.

9. An inspection method to be performed by a mobile terminal equipped with a camera, comprising:
displaying inspection information and drawing information based on an inspection sheet containing inspection information on an inspection object and drawing information on the inspection information;
inputting an inspection result corresponding to the inspection object;
inputting a shooting point of the inspection object;
shooting a plurality of images including a first image and a second image assuming the inspection object as an object to be shot;
specifying an association position, which is a position to be associated with the second image, of positions on the shot first image; and
storing inspection result data associating the first image and the second image with the inputted inspection result, the inputted shooting point, and the specified association position.

10. A recording medium storing a program including computer-executable instructions to be performed by a mobile terminal equipped with a camera, the instructions comprising:
displaying inspection information and drawing information based on an inspection sheet containing inspection information on an inspection object and drawing information on the inspection information;
inputting an inspection result corresponding to the inspection object;
inputting a shooting point of the inspection object;
shooting a plurality of images including a first image and a second image assuming the inspection object as an object to be shot;
specifying an association position, which is a position to be associated with the second image, of positions on the shot first image; and
storing inspection result data associating the first image and the second image with the inputted inspection result, the inputted shooting point, and the specified association position.
